(19) United States
(12) Patent Application Publication
(10) Pub. No.: US 2026/0328632 A1
(43) Pub. Date: Oct. 22, 2026

(54) SPEED REDUCTION TRANSMISSION DEVICE EQUIPPED WITH A TORQUE SENSOR

(71) Applicant: CHONGMO TECHNOLOGY CO., LTD., Kaohsiung City (TW)

(72) Inventor: Hsun-Yao Liang, Kaohsiung City (TW)

(21) Appl. No.: 19/206,761

(22) Filed: May 13, 2025

(30) Foreign Application Priority Data
Apr. 22, 2025 (TW) 114115191

(51) Int. Cl. G01L 3/10; F16H 49/00; G01L 5/00; H02K 7/116; H02K 11/24

(52) U.S. Cl. CPC G01L 3/104; F16H 49/001; G01L 5/0042; H02K 7/116; H02K 11/24

(57) ABSTRACT

A speed reduction transmission device equipped with a torque sensor, including a motor, a speed reduction transmission mechanism, and a rigid gear assembled in a housing. The motor can drive the speed reduction transmission mechanism to output a rotational kinetic energy of reduced speed. The rigid gear can guide the speed reduction transmission mechanism and withstand the torque transmitted from the speed reduction transmission mechanism. The rigid gear is formed with a flexible bracket for fixing the rigid gear inside the housing. The torque sensor comprises a linear sensor and a permanent magnet fixed between the housing and the annular end surface. The linear sensor can detect changes in the magnetic field intensity of the permanent magnet during the torque-bearing process of the rigid gear, thereby detecting the torque of the rotational kinetic energy of reduced speed. Through this design, the structural configuration of the device is optimized.

### BACKGROUND OF INVENTION

### 1. Field of the Invention

The present invention relates generally to detection and measurement of the output torque of a speed reduction transmission device, and more particularly to a speed reduction transmission device equipped with a torque sensor.

### 2. Description of Related Art

A speed reduction transmission device is usually equipped with a motor for power supply, a speed reduction transmission mechanism connected to the motor, generating a specific reduction ratio as required by the user, and a torque sensing element (or sensor) for detecting the torque output by the speed reduction transmission mechanism. Such devices are commonly used in industrial robots, humanoid robots, or prosthetic limb joints to precisely control the degrees of freedom and output force of artificial joints.

Existing speed reduction transmission mechanisms that can be used in speed reduction transmission devices include planetary gear systems (also called groups) and harmonic reducers. Planetary gear systems output rotational kinetic energy of reduced speed with a specific reduction ratio based on the gear ratio between the sun gear and the ring gear (or internal gear), while harmonic reducers achieve speed reduction through elastic deformation of metal materials.

Existing torque sensing elements that can be applied in speed reduction transmission devices typically include strain gauge and linear sensor. Strain gauges generate electrical signals when deformed due to their metal composition, enabling torque detection and measurement. Linear sensors detect the minor linear displacements of the objects along with their own to produce electrical signals. Among linear sensors, Hall sensors, which detect changes of the magnetic field strength generated by a permanent magnet due to the displacement, are particularly advanced.

According to the above-mentioned technical background, however, prior art (e.g., JP5659446B2, JP6496937B2, TWI640756B, CN109895112B, CN103610568B, U.S. Pat. No. 9,855,654) often mounts the torque sensing elements (or sensor) directly on movable components transmitting rotational kinetic energy of reduced speed. This limits torque measurement accuracy and risks tangling or damaging the sensor's wiring due to the rotational movement. Therefore, improvements become necessary.

### SUMMARY OF INVENTION

To address these shortcomings, the present invention improves the structure of the speed reduction transmission device by relocating the torque sensor away from movable components. This enhances torque measurement accuracy and eliminates the problem of wiring entanglement.

In one preferred embodiment of the invention, the speed reduction transmission device equipped with a torque sensor includes: a metal housing configured along a coaxial axis, containing a motor, a speed reduction transmission mechanism, and a rigid gear. The motor comprises a stator fixed inside the housing and a rotor pivoted within the stator. The speed reduction transmission mechanism connects to the rotor and outputs rotational kinetic energy of reduced speed. The rigid gear, made of metal, is fixed inside the housing to guide the speed reduction transmission mechanism and withstand its torque. Particularly, the rigid gear has an annular end face of equal circumferential radius, having at least one flexible bracket extending along the axis. The rigid gear is fixed inside the housing by the flexible bracket. The torque sensor includes a linear sensor and a permanent magnet fixed between the housing and the annular end face. The linear sensor (e.g., a Hall sensor) detects changes in the magnetic field strength of the permanent magnet as the rigid gear undergoes torque-induced deformation, enabling measurement of torque output by the speed reduction transmission device.

Based on the aforementioned technical means, the present invention differs from the prior art in that, neither the housing nor the rigid gear fixed inside the housing are movable components for transmitting rotational kinetic energy of reduced speed. This can avoid the problem of entanglement of the wiring of the linear sensor. Furthermore, the present invention leverages the fact that the rigid gear, while guiding the speed reduction transmission mechanism to output the rotational kinetic energy of reduced speed, simultaneously bears torsional forces. As a result, when affected by the output torque, the flexible brackets will have bending moment deformation due to the mechanical properties of their metallic material. This induces a minute relative displacement between the linear sensor and the permanent magnet, with the displacement magnitude being proportional to the output torque. In essence, the structural configuration of the brackets can enhance the precision of the output torque detected by the speed reduction transmission device.

In a further embodiment, the cross-section of the bracket can be rectangular, strip-shaped or M-shaped. The brackets can also be formed in pairs on the annular end face. When the cross-section of the bracket is rectangular, the two long sides of the rectangle are respectively perpendicular to the tangent of the annular end face, and the two short sides of the rectangle are respectively parallel or collinear with the tangent of the annular end face. The bracket generates the deformation of the bending moment through the two short sides. In addition, when the bracket is implemented as a strip-shaped body, the deformation of the bending moment can be generated through the two short sides of the strip-shaped body. Moreover, when the bracket is implemented as an M-shaped body, it has two symmetrical strip parts. Each strip part has two symmetrical short sides, and the bracket can generate the deformation of the bending moment through the two short sides.

In another embodiment as a variation, the annular end face is formed with paired recesses, and the bottom portion of the bracket forms a retaining portion capable of being fixed into the recesses, thereby mounting the bracket on the annular end face via these retaining portions. Further, the annular end face may extend along the axial path to form a boss, with the recesses respectively formed between the boss and the annular end face. Additionally, the boss provides a mounting surface where the permanent magnet is embedded. The linear sensor is fixed inside the housing, allowing the magnetic field strength generated by the magnetic flux to act upon the linear sensor.

Further embodiments include the following:

The housing comprises a housing base and a housing cover pivoted to each other. The rigid gear is fixed inside the housing base of the housing through the bracket, and extends into the housing cover to guide and support the speed reduction transmission mechanism. Specifically, the linear sensor is fixed inside the housing, the permanent magnet is fixed on the annular end face, allowing the magnetic field strength generated by the magnetic flux to act upon the linear sensor. The housing base is provided for fixing the stator, the rigid gear, part of the speed reduction transmission mechanism, and the linear sensor. The housing cover is provided for fixing the other part of the speed reduction transmission mechanism. As a result, the housing cover becomes a power output end of the speed reduction transmission device.

The speed reduction transmission mechanism can be composed of a harmonic reducer. The harmonic reducer includes a wave generator set and a flexible gear. The wave generator set includes an elliptical disc in transmission connection to the rotor and a flexible bearing coupled between the elliptical disc and the flexible gear. Moreover, the speed reducer is guided by the rigid gear through the flexible gear. Herein, the rigid gear is formed with a plurality of internal teeth distributed in a ring shape. The flexible gear is formed with a thin-walled portion capable of deformation and a thick-walled portion capable of maintaining rigid strength. The thin-walled portion has a smooth inner wall surface and a plurality of external teeth distributed in a ring shape on the periphery of the thin-walled portion. The flexible gear is coupled to the flexible bearing through the inner wall surface and meshes with part of the internal teeth of the rigid gear through the external teeth. Furthermore, the housing base provides a fixing structure for the stator and the rigid gear, and the housing cover provides a fixing structure for the thick-walled portion of the flexible gear, making the housing cover a power output end of the speed reduction transmission device. Alternatively:

The speed reduction transmission mechanism can be implemented as a planetary gear system. The planetary gear system includes at least one planetary gear set in transmission connection to the rotor and guided by the rigid gear. Specifically, the at least one planetary gear set comprises a first-stage planetary gear set that can achieve a first-stage reduction ratio. The first-stage planetary gear set comprises a first-stage sun gear in transmission connection to the rotor, a first-stage planetary gear carrier pivotally configured inside the housing, and a plurality of first-stage planetary gears pivoted on the first-stage planetary gear carrier and driven by the first-stage sun gear to revolve. The first-stage planetary gear set is guided and supported by the rigid gear through the plurality of first-stage planetary gears. The plurality of first-stage planetary gears also serve as a power output end for the speed reduction transmission device to generate rotational kinetic energy based on the first-stage reduction ratio. Furthermore, the housing base provides a fixing structure for the stator and the rigid gear. The housing cover is driven by the plurality first-stage planetary gears to enable the speed reduction transmission device to output rotational kinetic energy based on the first-stage reduction ratio via the housing cover.

Further, at least one of the aforementioned planetary gear sets further comprises a second-stage planetary gear set capable of generating rotational kinetic energy based on a second-stage gear ratio. The second-stage planetary gear set comprises a second-stage sun gear formed on the center of the first-stage planetary gear carrier, a second-stage planetary gear carrier pivoted inside the housing, and a plurality of second-stage planetary gears pivoted on the second-stage planetary gear carrier and driven by the second-stage sun gear to revolve. The second-stage planetary gear set is guided and supported by the rigid gear via the plurality of second-stage planetary gears. Moreover, a plurality of second-stage planetary gears also serves as a power output end for the speed reduction transmission device to generate rotational kinetic energy based on a second-stage reduction ratio. Furthermore, the housing base provides a fixing structure for the stator and the rigid gear. The housing cover is driven by the plurality of second-stage planetary gears to enable the speed reduction transmission device to output rotational kinetic energy based on the second-stage reduction ratio via the housing cover.

Further, the at least one planetary gear set also comprises a third-stage planetary gear set to generate rotational kinetic energy based on a third-stage reduction ratio. The third-stage planetary gear set includes a third-stage sun gear formed on the center of the second-stage planetary gear carrier, a third-stage planetary gear carrier pivoted inside the housing, and a plurality of third-stage planetary gears pivoted on the third-stage planetary gear carrier and driven by the third-stage sun gear to revolve. The third-stage planetary gear set is guided and supported by the rigid gear via the plurality of third-stage planetary gears. Moreover, a plurality of third-stage planetary gears also serves as a power output end for the speed reduction transmission device to generate rotational kinetic energy based on the third-stage reduction ratio. Furthermore, the housing base provides a fixing structure for the stator and the rigid gear. The housing cover is driven by the plurality of third-stage planetary gears to enable the speed reduction transmission device to output rotational kinetic energy based on the third-stage reduction ratio via the housing cover.

Further, the rotor is formed with a central pivot hole. The housing base is formed with a central seat that can fit into the central pivot hole. The rotor is pivoted between the central seat and the stator through the central pivot hole. The central seat is formed with a seat hole. The housing cover is formed with an internal central column. The housing cover is pivoted with the housing base through the central column.

Compared to prior art, the technical means of the present invention can not only effectively solve the problem of entanglement of the wiring of the linear sensor, but also enhance the accuracy in detecting the output torque. Moreover, the invention provides higher stability and longer life cycle of the linear sensor. The structural volume and internal space of the speed reduction transmission device can be further optimized and miniaturized through the invention.

The implementation content and technical effects disclosed above will be further described in more detail through the following drawings and implementation schemes.

### BRIEF DESCRIPTION OF THE DRAWINGS

FIG. 1 is an exploded perspective view of the first embodiment of the speed reduction transmission device according to, illustrating the harmonic reducer used as the speed reduction transmission mechanism of the invention.

FIG. 2 is a sectional view of FIG. 1.

FIG. 3a is a partial sectional view of FIG. 2, depicting the configuration of the brackets on the rigid gear, the permanent magnet and and the linear sensor on the housing.

FIG. 3b is an operational illustration of FIG. 3a, indicating that the deformation of the bracket will result in relative displacement between the linear sensor and the permanent magnet.

FIG. 3c is a sectional view of the bracket cross-section in FIG. 3a.

FIG. 3d is a perspective view of the bracket and rigid gear in FIG. 3a implemented as separated structures.

FIG. 4a is an exploded perspective view of a second embodiment of the rigid gear shown in FIG. 2, to illustrate another formation of the bracket.

FIG. 4b is a perspective view of a third embodiment of the rigid gear shown in FIG. 2, explaining the detachable assembly between the bracket and the annular end face.

FIG. 5 is an exploded perspective view of a second embodiment of the speed reduction transmission device according to the invention, disclosing the use of a planetary gear system to replace the harmonic reducer in FIG. 1 as the speed reduction transmission mechanism. Refer to FIG. 1 for other details.

FIG. 6 is a sectional view of FIG. 5.

### DETAILED DESCRIPTION OF THE INVENTION

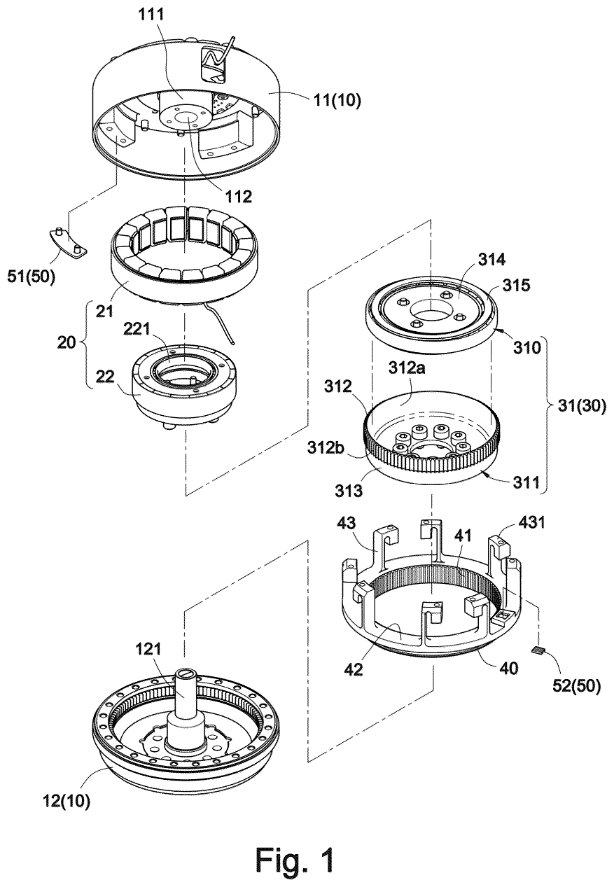

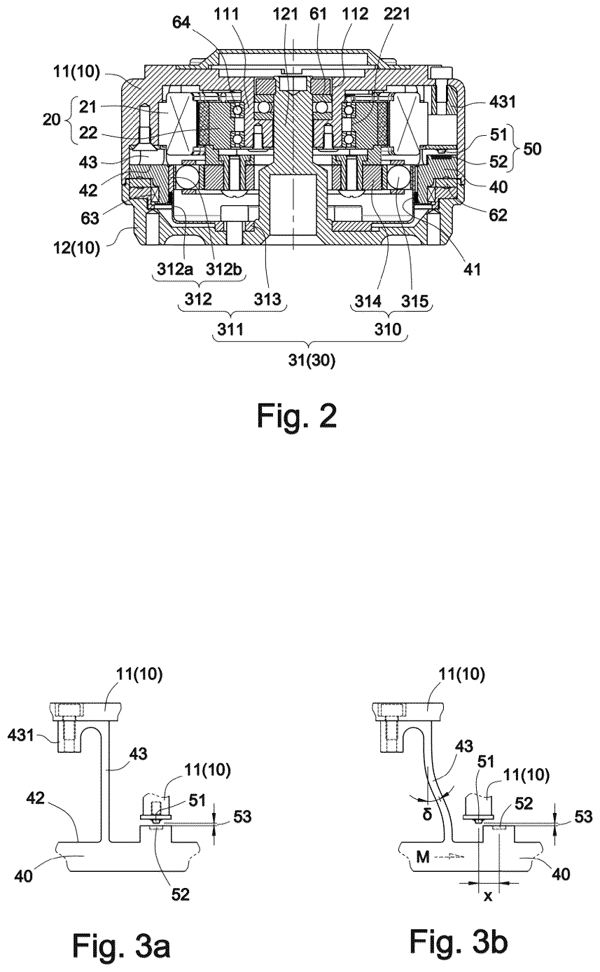

Firstly, please refer collectively to FIG. 1 and FIG. 2, which disclose the configuration of a first embodiment of the present invention. As depicted, the speed reduction transmission device has a metal housing 10. Inside the housing 10, a motor 20, a speed reduction transmission mechanism 30, a rigid gear 40, and a torque sensor 50 are configured along a coaxial path. The coaxial path is indicated by the center line in FIG. 2.

The motor 20 can be either a brushless DC motor or a permanent magnetic AC synchronous motor, and comprises a stator 21 fixed inside the housing 10 and a rotor 22 pivoted inside the stator 21. The rotor 22 is formed with a central pivot hole 221.

The speed reduction transmission mechanism 30 is used for transmission connection with the rotor 22, and to convert rotational kinetic energy supplied by the rotor 22 into a rotational kinetic energy of reduced speed, and export the rotational kinetic energy of reduced speed for use by the equipment end installed with the speed reduction transmission device. In the present embodiment, a harmonic reducer 31 made of a metallic material is used as the speed reduction transmission mechanism 30. The harmonic reducer 31 comprises a wave generator set 310 and a flexible gear 311.

Specifically, the wave generator set 310 comprises an elliptical disc 314 in transmission connection to the rotor 22, and a flexible bearing 315 connected between the elliptical disc 314 and the flexible gear 311. Moreover, the flexible gear 311 is formed with a thin-walled portion 312 capable of deformation and a thick-walled portion 313 capable of maintaining rigid strength. The thin-walled portion 312 has a smooth inner wall surface 312a and a plurality of external teeth 312b distributed in a ring shape on the periphery of the thin-walled portion 312. The flexible gear 311 can be coupled to the flexible bearing 315 through the inner wall surface 312a.

The rigid gear 40 also has a plurality of internal teeth 41 made of a rigid metallic material, distributed in a ring shape. The rigid gear 40 is also fixed inside the housing 10 along the coaxial path. In this way, the plurality of external teeth 312b of the flexible gear 311 can mesh with part of the internal teeth 41 of the rigid gear 40, and the rigid gear 40 can guide and support the flexible gear 311 of the harmonic reducer 31 (i.e., the speed reduction transmission mechanism 30).

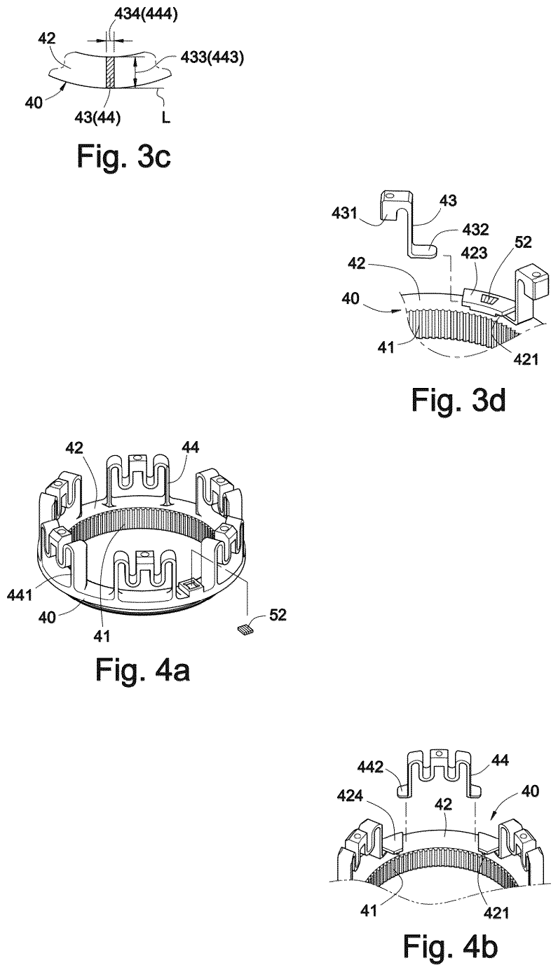

In addition, the rigid gear 40 is formed with an annular end face 42 with equal circumferential radius. The annular end face 42 extends along the axial path and is formed with paired flexible brackets 43, so that the rigid gear 40 can be fixed inside the housing 10 through the brackets 43. Here, it is not necessary that the brackets 43 are in pairs. Actually, it is to be understood that, as long as one or a plurality of brackets 43 are formed on the annular end face 42, any variation falls within the scope of the invention. Further, referring to FIG. 3a, the bracket 43 is integrally formed on the annular end face 42 in an upright manner, and one end of the bracket 43 is formed with a joining portion 431. Through the joining portion 431, a screw can be used to fix the bracket 43 on a top wall of the housing 10.

As depicted in FIG. 1 and FIG. 2, the torque sensor 50 comprises a linear sensor 51 and a permanent magnet 52 fixed between the housing 10 and the annular end face 42. Further, as can be seen from FIG. 3a, in a specific embodiment, the linear sensor 51 is fixed inside the housing 10, the permanent magnet 52 is fixed on the annular end face 42, and the linear sensor 51 and the permanent magnet 52 are separated from each other, forming an air gap 53.

Further, the linear sensor 51 can be composed of a Hall sensor. Thus, the magnetic flux of the permanent magnet 52 can generate a magnetic field to act upon the Hall sensor through the air gap 53. Under the Lorentz force, the electric current in the live circuit of the Hall sensor can generate a voltage. According to the Hall Effect, the voltage will be proportional to the strength of the magnetic field. Therefore, the stronger the magnetic field generated by the permanent magnet 52, the stronger signals will the Hall sensor generate, and vice versa. As disclosed in FIG. 3a, through the air gap 53, the Hall sensor can be induced by the magnetic field generated by the permanent magnet 52 and generate electrical signals.

Based on the configuration technique disclosed in the above first embodiment, the present invention can measure the torque of the rotational kinetic energy of reduced speed through the electrical signals generated by the Hall sensor.

In more details, as shown in FIG. 2, when the stator 21 of the motor 20 actuate the rotor 22 to rotate, it will simultaneously drive the elliptical disc 314 to rotate, causing the flexible bearing 315 and the thin-walled portion 312 of the flexible gear 311 to deform into a consistent elliptical shape. As a result, the flexible gear 311 is enclosed by the rigid gear 40 to rotate in the opposite direction. As the number of the external teeth 312b of the flexible gear 311 is less than the number of internal teeth 41 of the rigid gear 40 (usually by two teeth), and the thin-walled portion 312 of the flexible gear 311 has already deformed into an elliptical shape, only the external teeth 312b of the flexible gear 311 on the two opposite ends of the long axis of the ellipse can mesh with part of the internal teeth 41 of the rigid gear 40, and rotate slowly on internal teeth 41 of the rigid gear 40 with equal circumference.

In other words, when the rotor 22 drives the elliptical disc 314 to complete a full rotation (360 degrees), the flexible gear 311 will only rotate for a small arc of the whole circle (360 degrees) in the opposite direction (to be determined by the reduced number of the external teeth of the flexible gear), i.e., the rotational speed of the flexible gear 311 is relatively slower than the rotational speed generated by the rotor 22, thus achieving the function of harmonic speed reduction. In this way, through the flexible gear 311, the harmonic reducer 31 can output the rotational kinetic energy of reduced speed at a preset reduction ratio. During the speed reduction transmission, the rigid gear 40 guides and supports the flexible gear 311, and also withstands the torque transmitted from the flexible gear 311.

Please refer to FIG. 3a through FIG. 3b. As depicted in FIG. 3a, when the rigid gear 40 is not subjected to the torque, through the air gap 53, the Hall sensor is maintained at a position relative to the permanent magnet 52 with no displacement. Now, the Hall sensor can sense a high strength of the magnetic field generated by the permanent magnet 52, and can generate high-volt electrical signals. As shown in FIG. 3b, once the rigid gear 40 is subjected to the torque M transmitted from the flexible gear 311, it will cause the bracket 43 to generate a deformation ^{δ} under the bending force, and the rigid gear 40 will have a small displacement along the circumferential direction, resulting in a displacement x of the permanent magnet 52 relative to the Hall sensor. As the permanent magnet 52 is relatively displaced from the Hall sensor, the strength of the magnetic field generated by the permanent magnet 52 sensed by the Hall sensor will become gradually weaker, and the electrical signals generated will become weaker. In this way, according to the strength of the electrical signals, the present invention can measure and judge the torque of the rotational kinetic energy of reduced speed.

Please refer to FIG. 3c. As disclosed, the cross-section of the middle section of the bracket 43 shown in FIG. 1 is in the shape of a rectangle with two longer sides 433 and two shorter sides 434. The two longer sides 433 are respectively perpendicular to the tangent line L of the annular end face 42, and the two shorter sides 434 are respectively parallel or collinear to the tangent line L of the annular end face 42, such that the bracket 43 with a rectangular cross-section can generate deformation of the bending moment based on the relative thickness established by the two shorter sides 434. In other words, according to the disclosure in FIG. 1 and FIG. 3c, the bracket 43 located between the annular end face 42 and the housing 10 can also be defined as a strip shape, such that the strip-shaped bracket can generate deformation of the bending moment based on the relative thickness established by the two shorter sides 434.

Please refer to FIG. 3d. The bracket 43 shown in FIG. 1 can be fixed on the annular end face 42 in a detachable upright form. Moreover, the annular end face 42 is formed with paired recesses 421, and the bottom portion of the bracket 43 forms a retaining portions 432 capable of being fixed into the recesses 421, thereby fitting the bracket 43 into the recesses 421 of the annular end face 42 through the retaining portions 432 and mounting it on the annular end face 42. In this way, the production of the rigid gear 40 can be simplified.

FIG. 4a discloses another form of the bracket 44 located between the annular end face 42 and the housing 10. The bracket 44 can be formed in a flexible M-shaped body. The M shape has two symmetrical strip parts 441, each strip part 441 has two symmetrical longer sides 443 and two symmetrical shorter sides 444 (see FIG. 3c). Thus, the bracket 44 can generate the deformation of the bending moment through the two shorter sides 444.

As disclosed in FIG. 4b, the bracket 44 shown in FIG. 4a is fixed on the annular end face 42 in a detachable and upright form. Further, the annular end face 42 is formed with paired recesses 421. The bottom portion of the bracket 44 forms retaining portions 442 capable of being fixed into the recesses 421. Thus, by fitting the retaining portions 442 into the recesses 421 of the annular end face 42, the bracket 44 can be mounted on the annular end face 42. In this way, the production of the rigid gear 40 can also be simplified.

In the above embodiments shown in FIG. 4a and FIG. 4b, the annular end face 42 extends along the axial path to form a boss 423, 424, with the recesses 421 respectively formed between the boss 423, 424 and the annular end face 42. Specifically, each boss 423, 424 is respectively formed with a mounting surface to embed the permanent magnet 52.

The above first embodiment further discloses that the housing 10 can be in a ring shape, comprising a ring-shaped housing base 11 and a ring-shaped housing cover 12 pivoted to each other. Further, as shown in FIG. 1 and FIG. 2, the housing base 11 can be regarded as the fixing end of the transmission device, for fixation onto the equipment end requiring the rotational kinetic energy of reduced speed. The center of the housing base 11 can be formed with a central seat 111. A seat hole 112 can be provided on the central seat 111. The center of the housing cover 12 can be formed with a central column 121 that can be fitted into the seat hole 112. In this way, a first bearing 61 can be assembled between the seat hole 112 and the central column 121. Moreover, between the peripheries of the housing base 11 and the housing cover 12, a second bearing 62 and a third bearing 63 are mounted. Thus, the housing cover 12 can be pivoted with the housing base 11 through the central column 121, the first bearing 61, the second bearing 62, and the third bearing 63.

Further, through the housing base 11, the housing 10 provides fixation for the stator 21 and the rigid gear 40. By fitting at least one fourth bearing 64 in the central pivot hole 221, the rotor 22 can be pivoted between the outer wall of the central seat 111 and the stator 21. The housing cover 12 provides fixation for the thick-walled portion 313 of the flexible gear 311. In this way, by using the housing cover 12 as a power output end, the rotational kinetic energy output of reduced speed by the flexible gear 311 can be utilized by the equipment end.

In the above description, the central seat 111 and seat hole 112 on the housing base 11 can also be alternatively formed on the housing cover 12. If so, the central column 121 originally formed on the housing cover 12 is now formed on the housing base 11. In other words, as long as the housing base 11 and the housing cover 12 can be pivoted to each other and have interconnected internal holding chambers, any variation falls within the scope of the invention.

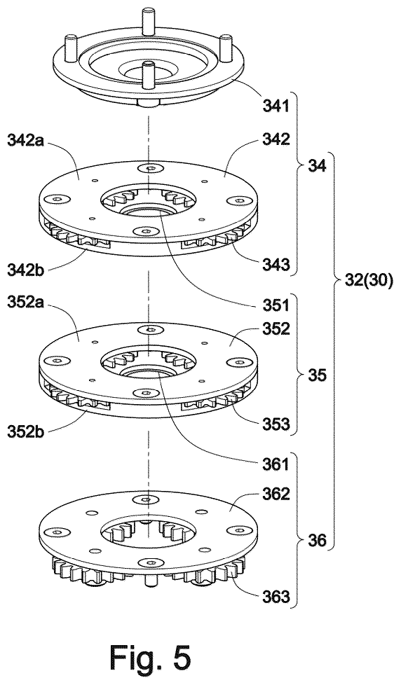

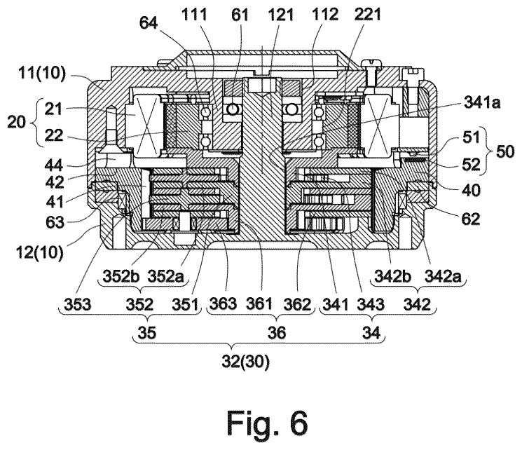

Please refer to FIG. 5 and FIG. 6, which disclose the configuration of the second embodiment of the invention. Different from the first embodiment shown in FIG. 1 and FIG. 2, the present embodiment uses a planetary gear system 32 to replace the aforementioned harmonic reducer 31 as the speed reduction transmission mechanism 30 of the invention. Other configuration details are the same as the first embodiment.

Specifically, the speed reduction transmission mechanism 30 composed of the planetary gear system 32 comprises a plurality of planetary gear sets in transmission connection with the rotor 22, guided and supported by the rigid gear 40.

As disclosed in FIG. 5, the plurality of planetary gear sets comprises a first-stage planetary gear set 34 that can achieve the first-stage reduction ratio, a second-stage planetary gear set 35 that can achieve the second-stage reduction ratio, and a third-stage planetary gear set 36 that can achieve the third-stage reduction ratio. In particular:

The first-stage planetary gear set 34 comprises a first-stage sun gear 341 in transmission connection with the rotor 22, a first-stage planetary gear carrier 342 pivoted inside the housing 10, and a plurality of first-stage planetary gears 343 pivoted on the first-stage planetary gear carrier 342 to be driven by the first-stage sun gear 341 to revolve. Further, the first-stage sun gear 341 is in the shape of a ring and can be fastened with the rotor 22 using a plurality of bolts. The external teeth 341a of the first-stage sun gear 341 are located on the bottom end of the first-stage sun gear 341 (as shown in FIG. 6). The first-stage planetary gear carrier 342 can be pivoted on the central column 121 of the housing cover 12. The first-stage planetary gear carrier 342 is formed with integral upper end disc surface 342a and lower end disc surface 342b. The plurality of first-stage planetary gears 343 are pivoted between the upper end disc surface 342a and lower end disc surface 342b in equal intervals at the same pitch circle, such that they can rotate freely. In this way, the rotor 22 can drive the first-stage planetary gear carrier 342 to rotate through the first-stage sun gear 341, and the plurality of first-stage planetary gears 343 can revolve along the axial path. During the revolution, the plurality of first-stage planetary gears 343 can be guided and supported by the rigid gear 40, and the rigid gear 40 can withstand the torque of the first-stage rotational kinetic energy of reduced speed (as shown in FIG. 6).

In other embodiments which feature easy variation to the configuration in FIG. 6, the plurality of first-stage planetary gears 343 can serve as the power output end for the transmission device to output rotational kinetic energy at the first-stage reduction ratio. In this way, the housing cover 12 can serve as the lower end disc surface 342b of the first-stage planetary gear carrier 342. The plurality of first-stage planetary gears 343 can be pivoted between the upper end disc surface 342a and the housing cover 12 of the first-stage planetary gear carrier 342, omitting the lower end disc surface 342b, the second-stage planetary gear set 35, and the third-stage planetary gear set 36.

Further, in implementations according to the configuration in FIG. 6, the second-stage planetary gear set 35 comprises a second-stage sun gear 351 formed on the center of the lower end disc surface 342b of the first-stage planetary gear carrier 342, a second-stage planetary gear carrier 352 pivoted on the central column 121 of the housing cover 12, and a plurality of second-stage planetary gears 353 pivoted on the second-stage planetary gear carrier 352 to be driven by the second-stage sun gear 351 to revolve. Here, the second-stage planetary gear carrier 352 is also formed with integral upper end disc surface 352a and lower end disc surface 352b. The plurality of second-stage planetary gears 353 are also pivoted between the upper end disc surface 352a and lower end disc surface 352b in equal intervals at the same pitch circle, such that they can rotate freely. Based on such a configuration, the second-stage sun gear 351 can transmit the rotational kinetic energy of reduced speed of the first-stage planetary gear set 34 and drive the second-stage planetary gear carrier 352 to rotate, so that the plurality of second-stage planetary gears 353 can revolve along the axial path. During the revolution, the plurality of second-stage planetary gears 353 can be guided and supported by the rigid gear 40, so that the rigid gear 40 can withstand the torque of the second-stage rotational kinetic energy of reduced speed.

In other implementations featuring easy variation to the configuration in FIG. 6, the plurality of second-stage planetary gears 353 can serve as the power output end for the transmission device to output rotational kinetic energy at the second-stage reduction ratio. In this way, the housing cover 12 can act as the lower end disc surface 352b of the second-stage planetary gear carrier 352. The plurality of second-stage planetary gears 353 can be pivoted between the upper end disc surface 352a and the housing cover 12 of the second-stage planetary gear carrier 352, omitting the lower end disc surface 352b and the third-stage planetary gear set 36.

Further, in implementations according to the configuration in FIG. 6, the third-stage planetary gears 36 comprises a third-stage sun gear 361 formed on the center of the lower end disc surface 352b of the second-stage planetary gear carrier 352, a third-stage planetary gear carrier 362 pivoted on the central column 121 of the housing cover 12, and a plurality of third-stage planetary gears 363 pivoted on the third-stage planetary gear carrier 362 to be driven by the third-stage sun gear 361 to revolve. Here, the third-stage planetary gear carrier 362 serves as the aforementioned upper end disc surface, and the housing cover 12 is used as the aforementioned lower end disc surface. The plurality of third-stage planetary gears 363 are pivoted between the third-stage planetary gear carrier 362 and the housing cover 12 in equal intervals at the same pitch circle, so that they can rotate freely. Based on such a configuration, the third-stage sun gear 361 can transmit the rotational kinetic energy of reduced speed of the second-stage planetary gear set 35 to drive the third-stage planetary gear carrier 362 to rotate, and the plurality of third-stage planetary gears 363 can revolve along the axial path. During the revolution, the plurality of third-stage planetary gears 363 can be guided and supported by the rigid gear 40, and the rigid gear 40 can withstand the torque of the third-stage rotational kinetic energy of reduced speed, and meanwhile, through the housing cover 12, output rotational kinetic energy at third-stage reduction ratio for use by the equipment end. Here, the rigid gear 40 can be considered as the ring gear (or internal gear) in the planetary gear system 32 having the function to guide and support the planetary gears. The reduction ratio to be achieved by each of the above different stages of planetary gear sets is determined by the number of teeth of the sun gear and the rigid gear in each stage.

Apart from this, the implementation details related to the torque sensor 50 in the second embodiment disclosed in FIG. 5 and FIG. 6 are all the same as the first embodiment. Through the torque sensor 50, the present invention can measure and read the torque of the rotational kinetic energy output of reduced speed from the planetary gear system 32.

Based on the description of the above embodiments, the present invention can truly enhance the accuracy of the speed reduction transmission device in detecting the output torque, and can overcome the problem of entanglement of the wiring of the torque sensing elements. Although the invention has been explained in relation to its preferred embodiment, it is to be understood that many other possible modifications and variations can be made without departing from the spirit and scope of the invention as hereinafter claimed.

1. A speed reduction transmission device equipped with a torque sensor, comprising the following components configured inside a housing along a coaxial path:
a motor, including a stator fixed inside the housing and a rotor pivoted inside the stator;
a speed reduction transmission mechanism, in transmission connection with the rotor for outputting a rotational kinetic energy of reduced speed;
a rigid gear, fixed inside the housing to guide and support the speed reduction transmission mechanism, and to withstand the torque of the speed reduction transmission mechanism; wherein,
the rigid gear is formed with an annular end face of equal circumferential radius, the annular end face extends along the axial path and is formed with at least one flexible bracket, the rigid gear is fixed inside the housing through bracket; and
the torque sensor comprises a linear sensor and a permanent magnet fixed between the housing and the annular end face, the linear sensor and the permanent magnet are separated from each other, forming an air gap, through the air gap, the linear sensor senses the change of magnetic field strength of the permanent magnet when the rigid gear is subjected to the torque, so as to measure and judge the torque of the rotational kinetic energy output of reduced speed from the speed reduction transmission mechanism.

2. The speed reduction transmission device equipped with a torque sensor defined in claim 1, wherein, when the rigid gear is subjected to the torque, the bracket has deformation under the bending force, causing the rigid gear to generate a displacement along the circumferential direction, the linear sensor detects the change of the magnetic field strength of the permanent magnet based on the displacement.

3. The speed reduction transmission device equipped with a torque sensor defined in claim 2, wherein the cross-section of the bracket is rectangular, the two longer sides of the rectangle are perpendicular to the tangent line of the annular end face, the two shorter sides of the rectangle are parallel or collinear to the tangent line of the annular end face, and the bracket can generate the deformation of the bending moment through the two shorter sides.

4. The speed reduction transmission device equipped with a torque sensor defined in claim 2, wherein the bracket is strip-shaped, located between the annular end face and the housing, and the bracket can generate the deformation of the bending moment through the two shorter sides of the strip shape.

5. The speed reduction transmission device equipped with a torque sensor defined in claim 2, wherein the bracket is M-shaped, located between the annular end face and the housing, the M shape has two symmetrical strip parts, each strip part has two symmetrical short sides, and the bracket can generate the deformation of the bending moment through the two short sides.

6. The speed reduction transmission device equipped with a torque sensor defined in claim 1, wherein the brackets are formed in pairs on the annular end face.

7. The speed reduction transmission device equipped with a torque sensor defined in claims 1, wherein the annular end face is formed with paired recesses corresponding to the brackets, and the bottom portion of the bracket forms retaining portions capable of being fixed into the recesses, thereby mounting the bracket on the annular end face via these retaining portions.

8. The speed reduction transmission device equipped with a torque sensor defined in claim 7, wherein the annular end face extends along the axial path to form a boss, with the recesses respectively formed between the boss and the annular end face.

9. The speed reduction transmission device equipped with a torque sensor defined in claim 8, wherein the boss provides a mounting surface, the permanent magnet is embedded into the mounting surface, the linear sensor is fixed inside the housing, allowing the magnetic field strength generated by the magnetic flux to act upon the linear sensor.

10. The speed reduction transmission device equipped with a torque sensor defined in claims 1, wherein the housing comprises a housing base and a housing cover pivoted to each other, the rigid gear is fixed inside the housing base of the housing through the bracket, and extends into the housing cover to guide and support the speed reduction transmission mechanism.

11. The speed reduction transmission device equipped with a torque sensor defined in claim 1, wherein said linear sensor is fixed inside the housing, said permanent magnet is fixed on the annular end face to generate a magnetic field with specific strength to act upon the linear sensor.

12. The speed reduction transmission device equipped with a torque sensor defined in claim 11, wherein the housing comprises a housing base and a housing cover pivoted to each other, the housing base provides fixation for the stator, the rigid gear, part of the speed reduction transmission mechanism, and the linear sensor, the housing cover provides fixation for the other part of the speed reduction transmission mechanism, such that the housing cover becomes a power output end of the speed reduction transmission device.

13. The speed reduction transmission device equipped with a torque sensor defined in claim 1, wherein the speed reduction transmission mechanism is composed of a harmonic reducer, the harmonic reducer comprises a wave generator set and a flexible gear, the wave generator set comprises an elliptical disc in transmission connection to the rotor and a flexible bearing coupled between the elliptical disc and the flexible gear, and the speed reduction transmission mechanism is guided and supported by the rigid gear through the flexible gear.

14. The speed reduction transmission device equipped with a torque sensor defined in claim 13, wherein the rigid gear is formed with a plurality of internal teeth distributed in a ring shape, the flexible gear is formed with a thin-walled portion capable of deformation and a thick-walled portion capable of maintaining rigid strength, the thin-walled portion has a smooth inner wall surface and a plurality of external teeth distributed in a ring shape on the periphery of the thin-walled portion, the flexible gear is coupled to the flexible bearing through the inner wall surface and meshes with part of the internal teeth of the rigid gear through the external teeth.

15. The speed reduction transmission device equipped with a torque sensor defined in claim 14, wherein the housing comprises a housing base and a housing cover pivoted to each other, the housing base provides fixation for the stator and the rigid gear, the housing cover provides fixation for the thick-walled portion of the flexible gear, such that the housing cover becomes a power output end of the speed reduction transmission device.

16. The speed reduction transmission device equipped with a torque sensor defined in claim 1, wherein the speed reduction transmission mechanism is composed of a planetary gear system, and the planetary gear systems comprises at least one planetary gear set which is in transmission connection to the rotor and guided and supported by the rigid gear.

17. The speed reduction transmission device equipped with a torque sensor defined in claim 16, wherein the at least one planetary gear set comprises a first-stage planetary gear set that can achieve the first-stage reduction ratio, the first-stage planetary gear set comprises a first-stage sun gear in transmission connection to the rotor, a first-stage planetary gear carrier pivotally configured inside the housing, and a plurality of first-stage planetary gears pivoted on the first-stage planetary gear carrier and driven by the first-stage sun gear to revolve, the first-stage planetary gear set is guided and supported by the rigid gear through the plurality of first-stage planetary gears, and the plurality of first-stage planetary gears also serve as a power output end for the speed reduction transmission device to generate rotational kinetic energy based on the first-stage reduction ratio.

18. The speed reduction transmission device equipped with a torque sensor defined in claim 17, wherein the housing comprises a housing base and a housing cover pivoted to each other, the housing base provides fixation for the stator and the rigid gear, the housing cover is driven by the plurality of first-stage planetary gears, such that the speed reduction transmission device can output rotational kinetic energy at the first-stage reduction ratio through the housing cover.

19. The speed reduction transmission device equipped with a torque sensor defined in claim 17, wherein the at least one planetary gear set also comprises a second-stage planetary gear set that can achieve a second-stage reduction ratio, the second-stage planetary gear set comprises a second-stage sun gear formed on the center of the first-stage planetary gear carrier, a second-stage planetary gear carrier pivoted inside the housing, and a plurality of second-stage planetary gears pivoted on the second-stage planetary gear carrier and guided and supported by the second-stage sun gear to revolve, the second-stage planetary gear set is guided and supported by the rigid gear through the plurality of second-stage planetary gears, and the plurality of second-stage planetary gears also serve as a power output end for the speed reduction transmission device to generate rotational kinetic energy at the second-stage reduction ratio.

20. The speed reduction transmission device equipped with a torque sensor defined in claim 19, wherein the housing comprises a housing base and a housing cover pivoted to each other, the housing base provides fixation for the stator and the rigid gear, the housing cover is driven by the plurality of second-stage planetary gears, such that the speed reduction transmission device can output rotational kinetic energy at the second-stage reduction ratio through the housing cover.

21. The speed reduction transmission device equipped with a torque sensor defined in claim 19, wherein the at least one planetary gear set also comprises a third-stage planetary gear set that can achieve a third-stage reduction ratio, the third-stage planetary gear set comprises a third-stage sun gear formed on the center of the second-stage planetary gear carrier, a third-stage planetary gear carrier pivoted inside the housing, and a plurality of third-stage planetary gears pivoted on the third-stage planetary gear carrier and driven by the third-stage sun gear to revolve, the third-stage planetary gear set is guided and supported by the rigid gear through the plurality of third-stage planetary gears, and the plurality of third-stage planetary gears also serve as a power output end for the speed reduction transmission device to generate rotational kinetic energy at the third-stage reduction ratio.

22. The speed reduction transmission device equipped with a torque sensor defined in claim 21, wherein the housing comprises a housing base and a housing cover pivoted to each other, the housing base provides fixation for the stator and the rigid gear, the housing cover is driven by the plurality of third-stage planetary gears, such that the speed reduction transmission device can output rotational kinetic energy at the third-stage reduction ratio through the housing cover.

23. The speed reduction transmission device equipped with a torque sensor defined in claim 1, wherein the rotor is formed with a central pivot hole, the housing comprises a housing base and a housing cover pivoted to each other, the housing base is formed with a central seat that can fit into the central pivot hole, the rotor is pivoted between the central seat and the stator through the central pivot hole, the central seat is formed with a seat hole, the housing cover is internally extended to form a central column, the housing cover is pivoted with the housing base through the central column.

24. The speed reduction transmission device equipped with a torque sensor defined in claim 1, wherein said linear sensor is a Hall sensor.
